(19) United States
(12) Patent Application Publication
(10) Pub. No.: US 2013/0309894 A1
(43) Pub. Date: Nov. 21, 2013

(54) I/O MOUDLE OF ELECTRONIC DEVICE

(71) Applicants: Hong Fu Jin Precision Industry (WuHan) Co., Ltd., (US); HON HAI PRECISION INDUSTRY CO., LTD., New Taipei (TW)

(72) Inventors: CHAO GENG, Wuhan (CN); QIU-HUA BIN, Wuhan (CN); TAI-BAO WU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/715,021

(22) Filed: Dec. 14, 2012

(30) Foreign Application Priority Data
May 15, 2012 (CN) 201210149657.5

(51) Int. Cl. H01R 13/625

(52) U.S. Cl. CPC H01R 13/625
USPC 439/345

(57) ABSTRACT

An electronic device input and output (I/O) assembly includes a bracket, a first I/O module, and a second I/O module. The first I/O module includes a first connector. The second I/O module is detachably mounted to the first I/O module. The second I/O module includes a second connector. The second connector has a different type with the first connector. The bracket can mount both the first I/O module and the second I/O module to a bezel of an electronic device.

### BACKGROUND

The disclosure generally relates to input and output modules of electronic device.

### DESCRIPTION OF RELATED ART

Input and output (I/O) module is the communication between an electronic device and peripheral devices. The I/O module may include USB connectors, audio connectors, and video connectors, for example. These connectors are usually integrated to a single I/O bracket. The I/O bracket with the connectors is used in plurality of different electronic devices. However, different electronic devices may require different group of I/O connectors. The predefined integral I/O bracket cannot adapt all kinds of the electronic device. There are rooms for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembly view of an electronic device in one embodiment.

FIG. 2 is an exploded, isometric view of an I/O assembly of the electronic device in one embodiment.

FIG. 3 is similar to FIG. 2, but shown from another aspect.

FIG. 4 is an assembly view of the I/O assembly of FIG. 2.

FIG. 5 is similar to FIG. 4, but only a first I/O module is mounted to a bracket.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

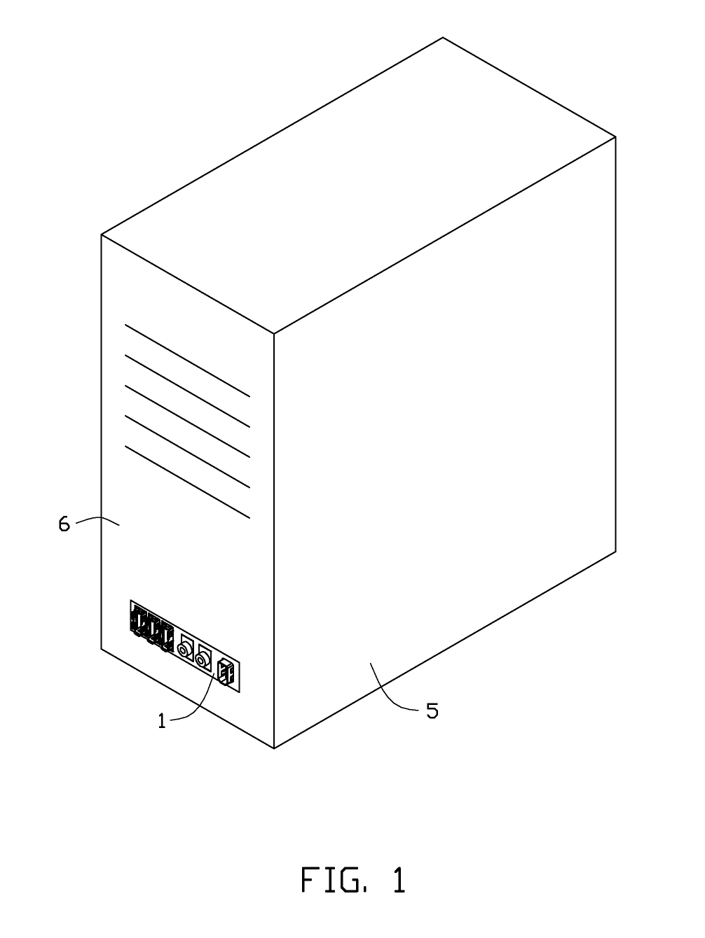

FIG. 1 is one embodiment of an electronic device. The electronic device includes a chassis 5, a bezel 6, and an input and output (I/O) assembly 1 mounted to the bezel 6. The electronic device may be a computer.

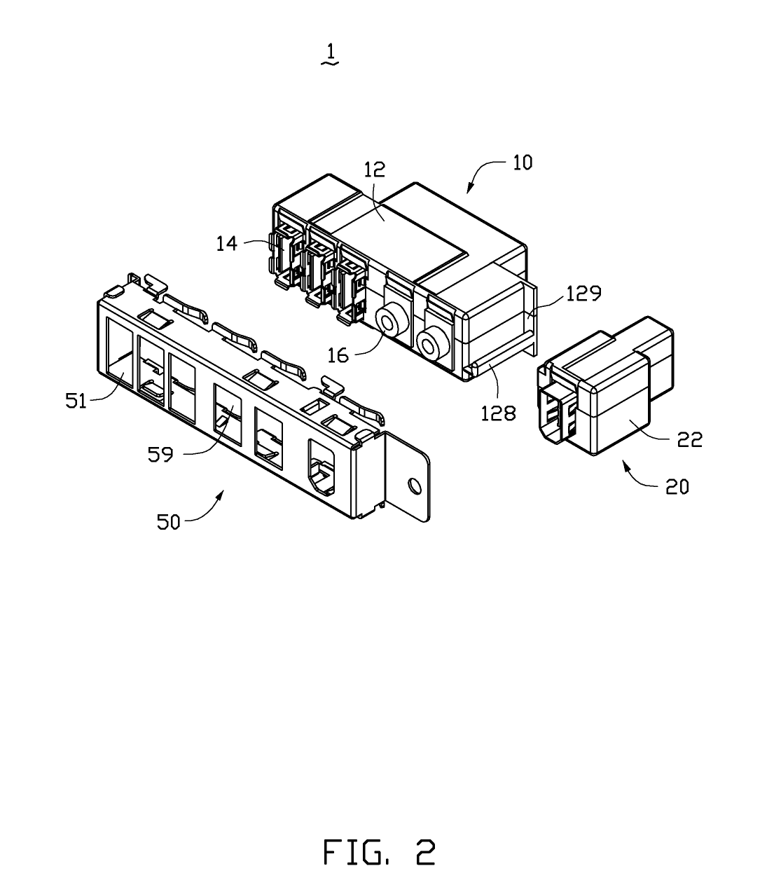

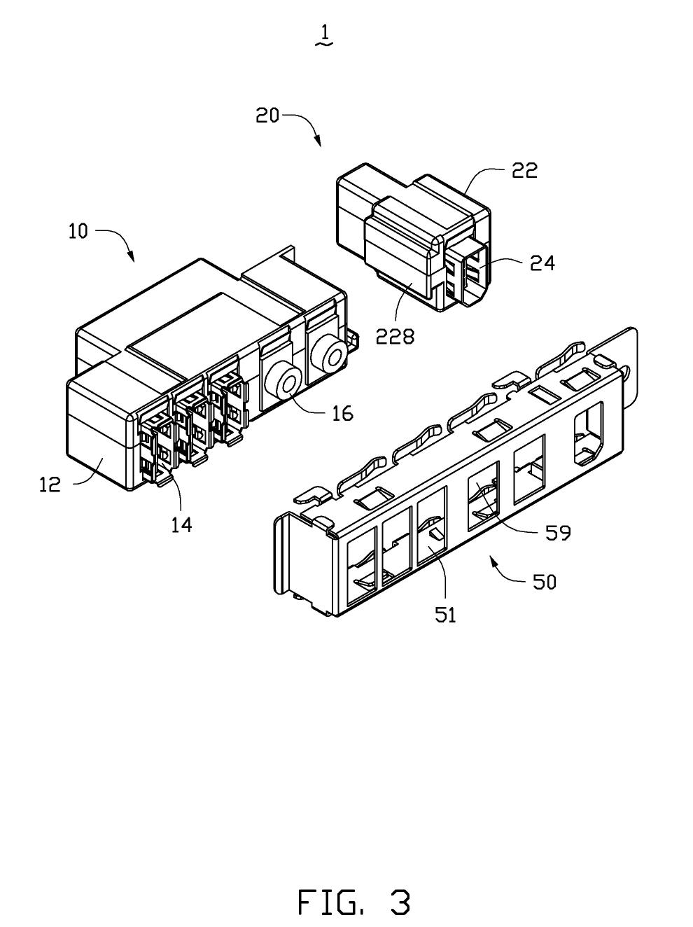

FIG. 2 and FIG. 3 show the I/O assembly 1 of the embodiment. The I/O assembly 1 includes a bracket 50, a first I/O module 10 and a second I/O module 20.

The first I/O module 10 includes a first I/O enclosure 12, and a plurality of first connectors assembled in the first I/O enclosure 12. The plurality of first connectors may include a plurality of USB connectors 14 and a plurality of audio connectors 16. The plurality of USB connectors 14 and the plurality of audio connectors 16 are aligned in a straight line. The first I/O enclosure 12 is integrally formed and is made of plastic. The first I/O enclosure 12 is elongated. A first locking member 128 is located at a side of the first I/O enclosure 12. The first locking member 128 has an L-shaped cross-section. An extending direction of the first locking member 128 is substantially parallel to an insertion direction of the first connector. A baffle plate 129 is located on a back of the first locking member 128 for blocking the second I/O module 20. The USB connector 14 may be USB 2.0 bus, USB 3.0 bus or other standard USB bus. The plurality of audio connectors 16 may include audio input or audio output bus. In other embodiments, the first I/O module 10 may include a secure digital (SD) memory card reader connector.

The second I/O module 20 includes a second I/O enclosure 22. A second connector is mounted in the second I/O enclosure 22. The second connector may be an IEEE 1394 connector 24. A second locking member 228 is located on a side of the second connector, to engage with the first locking member. The second locking member 228 has an L-shaped cross-section. The second connector is a selective connector to the electronic device.

The bracket 50 may be made of sheet metal. The bracket 50 defines a receiving space 59 to receive the first I/O module 10 and the second I/O module 20. The bracket 50 defines a plurality of openings 51 to install the first connectors and the second connector.

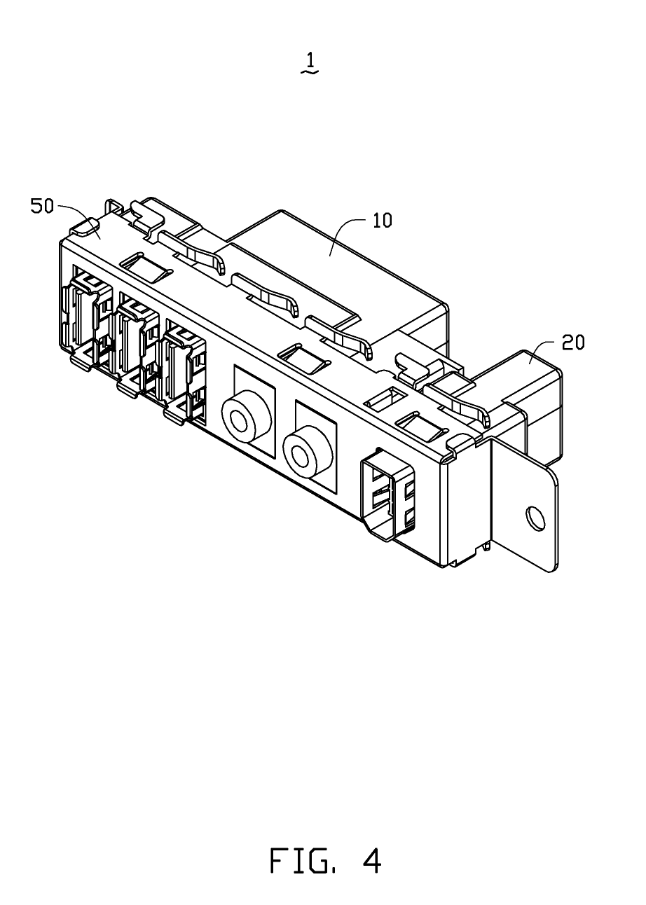

FIG. 4 shows that when both the first I/O module 10 and the second I/O module 20 are required in the electronic device, the second I/O module 20 is slid onto the first I/O module 10 with the first locking member 128 engaged with the second locking member 228. The first I/O module 10 and the second I/O module 20 are both installed into the receiving space 59 of the bracket 50. The first connectors and the second connector extend through the opening 51 of the bracket 50. The I/O assembly is mounted to the bezel 6.

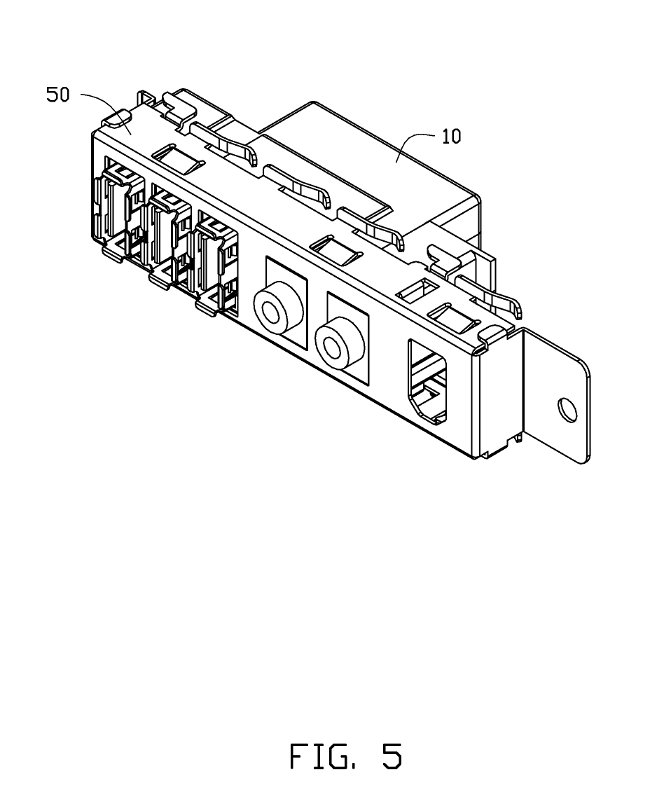

FIG. 5 shows that when only the first I/O module 10 is required in the electronic device, the first I/O module 10 is directly installed into the receiving space 59 of the bracket 50. The first connectors extend through the opening 51 of the bracket 50. The first I/O module 10 can be engaged with other I/O modules with different types of connectors as requirement of the electronic device.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device input and output (I/O) assembly, comprising:
a bracket;
a first I/O module, the first I/O module comprising a first connector; and
a second I/O module detachably mounted to the first I/O module, the second I/O module comprising a second connector, and the second connector comprising a different type with the first connector;
wherein the bracket is configured to mount both the first I/O module and the second I/O module to a bezel of an electronic device.

2. The electronic device I/O assembly of claim 1, wherein the bracket is configured to receive both the first I/O module and the second I/O module.

3. The electronic device I/O assembly of claim 1, wherein one of the first connector and the second connector is a USB connector.

4. The electronic device I/O assembly of claim 1, wherein one of the first connector and the second connector is an audio connector.

5. The electronic device I/O assembly of claim 1, wherein one of the first connector and the second connector is an IEEE 1394 connector.

6. The electronic device I/O assembly of claim 1, wherein the first connector comprises a first locking member, and the second connector comprises a second locking member engaged with the first locking member.

7. The electronic device I/O assembly of claim 6, wherein a first extending direction of the first locking member is substantially parallel to a second extending direction of the second locking member, and the first extending direction is substantially parallel to an insertion direction of the first connector.

8. The electronic device I/O assembly of claim 7, wherein a cross-section of each of the first locking member and the second locking member is L-shaped.

9. An electronic device, comprising:
a bezel; and
a input and output (I/O) module mounted to the bezel, the I/O module comprising:
a bracket;
a first I/O module, the first I/O module comprising a first connector; and
a second I/O module detachably mounted to the first I/O module, the second I/O module comprising a second connector, and the second connector having a different type with the first connector;
wherein the bracket is configured to mount the first I/O module to the bezel.

10. The electronic device of claim 9, wherein the bracket is configured to receive both the first I/O module and the second I/O module.

11. The electronic device of claim 9, wherein one of the first connector and the second connector is a USB connector.

12. The electronic device of claim 9, wherein one of the first connector and the second connector is an audio connector.

13. The electronic device of claim 9, wherein one of the first connector and the second connector is an IEEE 1394 connector.

14. The electronic device of claim 9, wherein the first connector comprises a first locking member, and a second connector comprises a second locking member to engage with the first locking member.

15. The electronic device of claim 14, wherein a first extending direction of the first locking member is substantially parallel to a second extending direction of the second locking member, and the first extending direction is substantially parallel to an insertion direction of the first connector.

16. The electronic device of claim 15, wherein a cross-section of each of the first locking member and the second locking member is L-shaped.
